(19) United States
(12) Patent Application Publication
(10) Pub. No.: US 2005/0102278 A1
(43) Pub. Date: May 12, 2005

(54) Expanded search keywords

(75) Inventor: Kaoru Okumura, Redmond, WA (US)

Correspondence Address: Christopher L. Holt;Westman, Champlin & Kelly, Suite 1600, 900 Second Avenue South, Minneapolis, MN, 55402-3319, US

(73) Assignee: Microsoft Corporation, Redmond, WA (US)

(21) Appl. No.: 10/706,124

(22) Filed: Nov. 12, 2003

(51) Int. Cl. G06F 17/30

(52) U.S. Cl. 707/3

(57) ABSTRACT

A method for providing additional terms to a searching process based on a string is provided. The method includes receiving a string that incorporates a plurality of characters separated by at least one space or hyphen. In one aspect, the plurality of characters is concatenated to form at least one additional term. In another aspect, a space is replaced with a hyphen. In yet another aspect, a hyphen is replaced with a space. The at least one additional term is provided to the search process.

### BACKGROUND OF THE INVENTION

The present invention generally pertains to the execution of query searches in the context of a search engine. More particularly, the present invention pertains to a method for providing an expanded range of search terms to a search engine based on an input search string.

Search engines configured to receive a search string and generate a corresponding result set are known in the art. Generally speaking, the result set is a collection of data items in a database that incorporate components that correspond to the input search string. A user typically reviews the result set and identifies data items of interest. For example, a user may select an indication of a data item in order to gain access to an expanded version thereof. In some cases, the result set is organized such that data items are ranked with items that most thoroughly reflect the input search string (i.e., contain the greatest number of input search string component instances) are listed at the top of a list and lesser representations are at the bottom.

It is not uncommon for a user to initiate multiple searches to generate a desirable result set. In many cases, a user must re-try the same search string in several different formats to ascertain which format is most prevalent in the database associated with the search engine. For example, a user might input “Windows XP” and not be satisfied with the result set. The same user might input “WindowsXP” in a subsequent search in order to generate a more satisfactory result set. These types of re-try searches require an extra investment of user time and energy.

Methods presently known to expand a search string to include keywords that are related to, but not included in, the input search string. For example, some search engines will include synonym lists that cover common variations of terms. When an input search string includes a term on the synonym list, equivalent terms are automatically added to the searching process. In other words, alternative keywords are provided based on the synonym list.

The effectiveness of the process of incorporating a synonym list is limited at least to the scope of the coverage of the list itself. The expansion of searches is limited to variations included on the synonym list. New expressions and common terminology will not initiate creation of expanded searches. It is also significant that the cost associated with maintaining a synonym list is relatively high. Generally speaking, such lists must be maintained, and expanded upon, through human interaction.

### SUMMARY OF THE INVENTION

A method for providing additional terms to a searching process based on a string is provided. The method includes receiving a string that incorporates a plurality of characters separated by at least one space or hyphen. In one aspect, the plurality of characters is concatenated to form at least one additional term. In another aspect, a space is replaced with a hyphen. In yet another aspect, a hyphen is replaced with a space. The at least one additional term is provided to the search process.

### BRIEF DESCRIPTION OF THE DRAWINGS

FIG. 1 is a block diagram of one computing environment in which the present invention may be practiced.

FIG. 2 is a diagrammatic illustration of searching environment in which embodiments of the present invention are useful.

FIG. 3 is a diagrammatic view of another searching environment in which embodiments of the present invention are useful.

FIG. 4 is a block diagram of a method of executing a search in accordance with an embodiment of the present invention.

FIG. 5 is a diagrammatic view of an algorithmic approach to an N-word search string.

### DETAILED DESCRIPTION OF ILLUSTRATIVE EMBODIMENTS

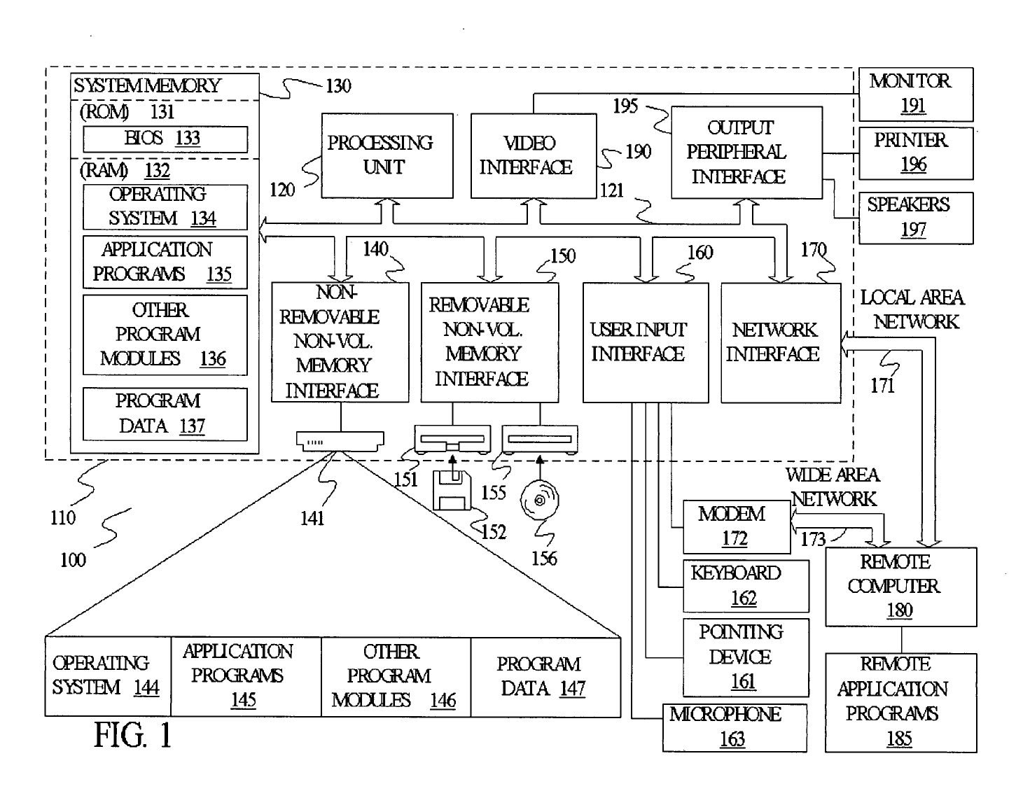

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general-purpose computing device in the form of a computer 110. Components of computer 110 may include, but are not limited to, a central processing unit 120, a system memory 130, and a system bus 121 that couples various system components including the system memory to the processing unit 120.

The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

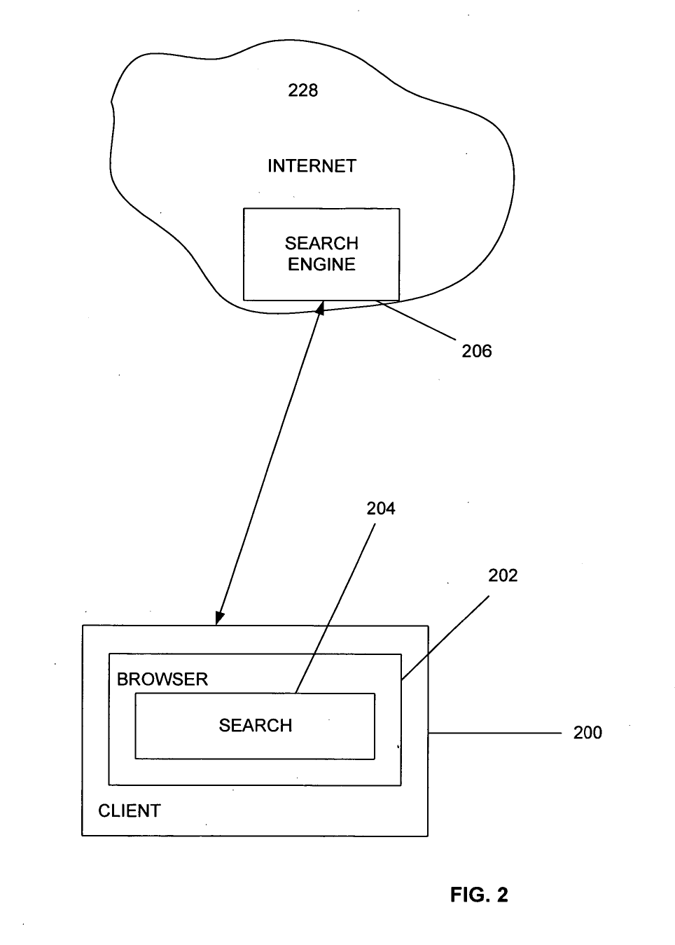

FIG. 2 illustrates a first environment in which embodiments of the present invention may operate. Client system 200 is a general-purpose computer such as any of those described above with respect to FIG. 1. A browser application 202, such as Internet Explorer available from Microsoft Corporation of Redmond Washington, is running on system 200. Module 204, in accordance with an embodiment of the present invention, is also operating within or alongside browser 202. Module 204 operates to enhance keyword-based searches as will be described in greater detail below. FIG. 2 simply illustrates module 204 residing within system 200, such that the enhanced keyword searching can be provided to a standard search engine. This embodiment allows advantages of the present invention to be achieved without modifying standard search engine 206. As used herein, “search engine” is an application that can query a set of data to obtain a list of results that may relate to the search term(s). As such, a search engine can be a web-based search engine, or a software module that searches a collection of data such as a database.

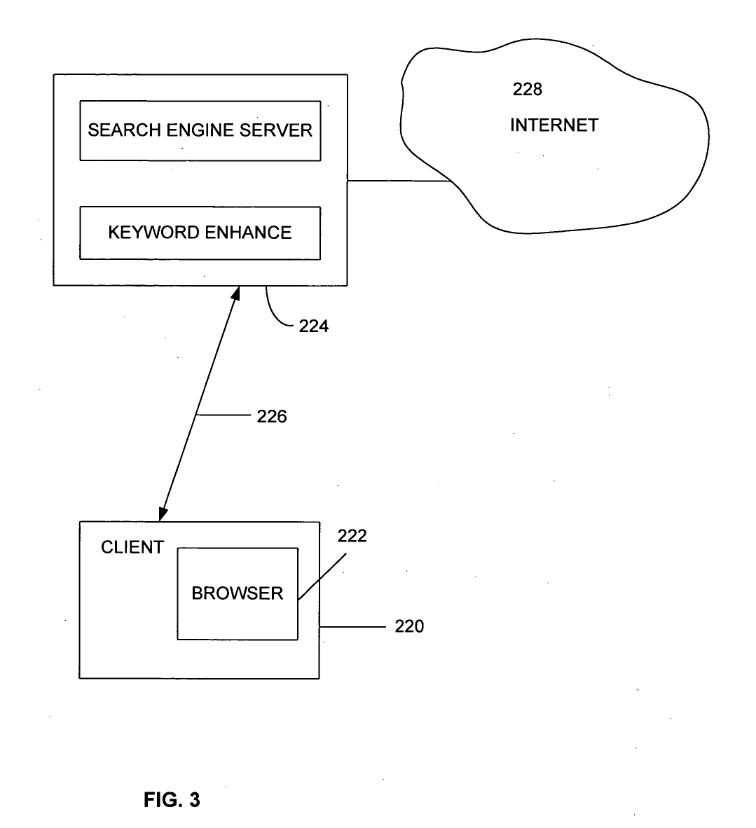

FIG. 3 is a diagrammatic view of another environment in which embodiments of the present invention can operate. FIG. 3 illustrates a standard client 220 running browser 222, which browser is not adapted to provide expanded search words. Instead, the user's search terms are concatenated in accordance with an embodiment of the present invention on the server-side. Thus, the search terms are transmitted from client 220 to search engine 224 over link 226. Link 226 can include an internet connection, a LAN connection or any suitable combination of the two. Server 224 may be located physically remote from client 220, located at the same facility as client 220, or even resident within client 220 as a software module.

Search engine 224 generates additional search terms in accordance with an embodiment of the present invention, as will be described in greater detail below. The original search terms and the additional server-generated search terms are then run as a search against a collection of data, such as web pages on internet 228. The results are then provided to client 220, in any suitable form, over link 226.

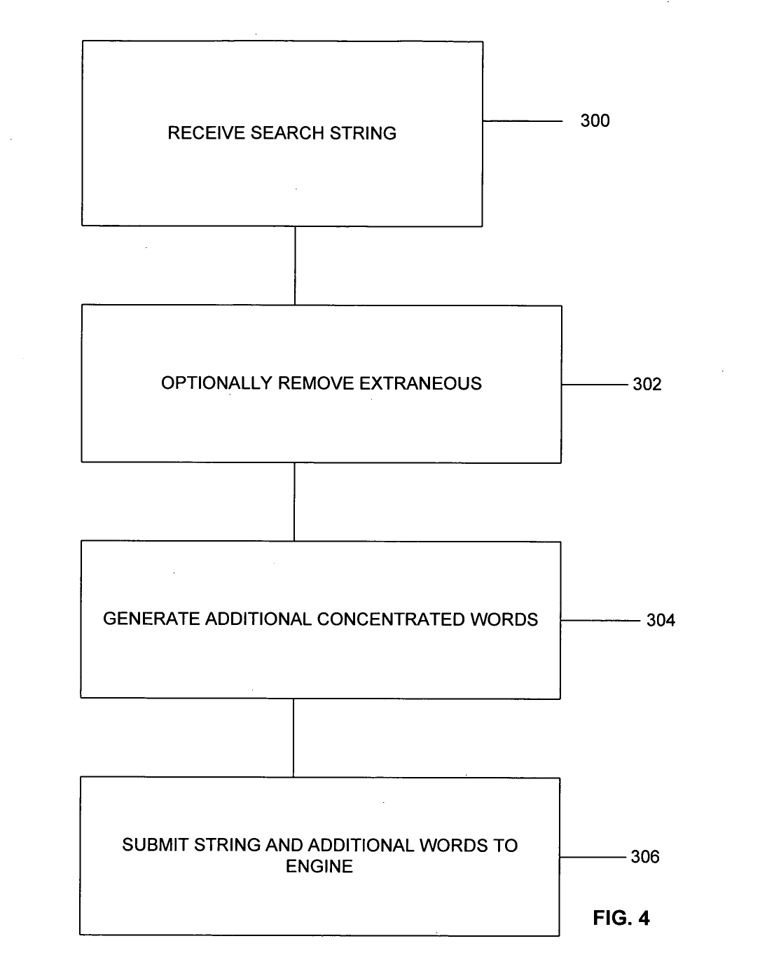

FIG. 4 is a block diagram of a method of executing a search in accordance with an embodiment of the present invention. The method begins at block 300 when a user provides a search string. As used herein a “search string” is two or more characters or symbols that are separated by a space or hyphen. While the remaining description of embodiments of the present invention will be described with respect to removing a space, it is to be understood that such embodiments include both the removal of a space, a hyphen, and any combination of the two. Also, it should be noted that embodiments of the present invention include replacing a space with a hyphen and the reverse.

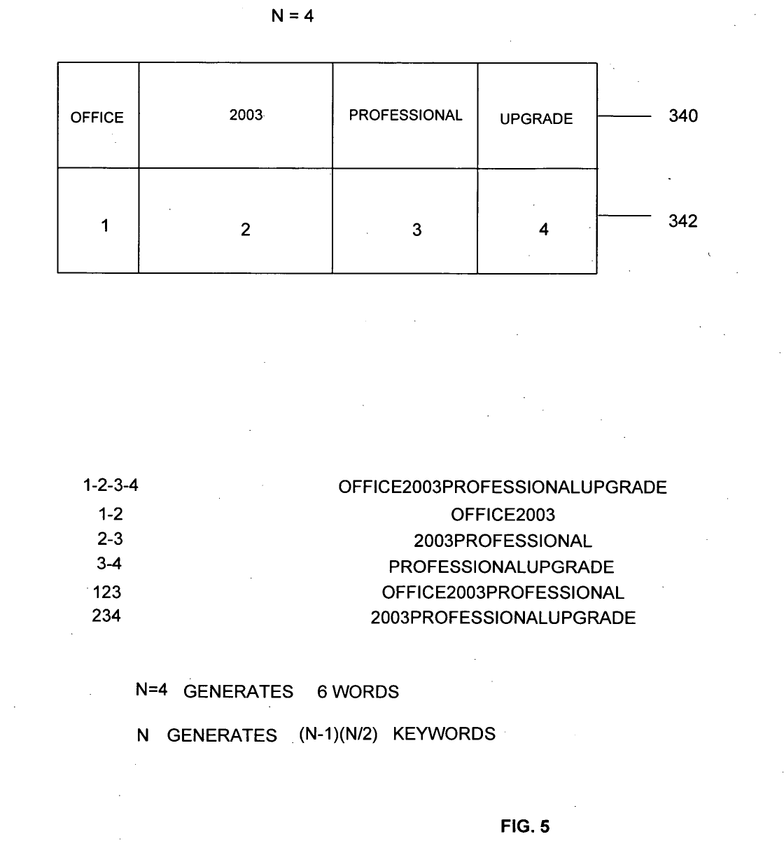

Examples of relevant strings include “Windows 2000” and “Windows XP”. Block 302 provides an optional step of removing extraneous characters. A list of extraneous characters can be provided a priori, or managed during run-time. These extraneous characters are characters that are usually part of a sentence, but do not add significant content or context. Examples of such extraneous characters might include “that”, “or”, “to”, “a”, . . . et cetera. Block 302 illustrates one example of pre-processing, other forms of preprocessing are within the scope of the present invention. Once the extraneous characters are optionally removed, the method passes to block 304 where additional keywords are generated through concatenation. A more detailed description of the process of block 304 is set forth below with respect to FIG. 5, but essentially this step involves the creation of additional keywords for the search by concatenating the user-provided keywords. For example, if a user wishes to search “Windows XP”, the additional keyword provided in accordance with the present invention is the concatenation of the two words to “WindowsXP”. Traditionally, a search for “Windows XP” would be broken down into three search words: “Windows XP”; “Windows” and “XP”. Embodiments of the invention add the additional concatenated word “WindowsXP”. In accordance with one embodiment, the additional concatenated keywords are re-indexed with the original search keywords. Additionally, some restrictions/suppression may be applied at this stage in order to reduce the possibility of over-generation, as described below. Once the search words have been prepared, control passes to block 306 where the search is run using the expanded set of search words. The mechanics of the search itself, and the manner in which the search results are reported are known in the art.

In accordance with one embodiment, rather than being applied exclusively to the query process, the algorithms described herein can be applied in the context of index creation. In other words, all documents that are search targets can be analyzed by a word-breaker in light of the algorithms described herein. In accordance with one embodiment, the algorithms (e.g., concatenation and otherwise) can be applied at index and/or query time.

FIG. 5 is a diagrammatic view of an algorithmic approach to an N-word search string. A four-word string of “OFFICE 2003 PROFESSIONAL UPGRADE” is provided at row 340. For reference, a row 342 indicating word position is also provided. The method generates all two-word combinations based upon word adjacency. Thus, “OFFICE2003”, “2003PROFESSIONAL”, and “PROFESSIONALUPGRADE” are created. Then the three-word combinations are created: “OFFICE2003PROFESSIONAL” and “2003PROFESSIONALUPGRADE”. This is continued until the final combination includes all search words with no spaces. Suppression may be applied in regard to the level or number of words or characters that can be concatenated. For example, it may be determined that no more that three words should be concatenated in order to reduce over-generation. The method of generating search words listed above will generate an additional (N-1) (N/2) search words for a given N-word search string input.

Embodiments of the present invention work well in the context of English language word groupings, and particularly well in non-alphabetical languages such as, but not limited to Japanese and Chinese. This is because these languages have fewer non-hyphen essential concatenated additional key words in the context of searching, etc.

Although the present invention has been described with reference to particular embodiments, workers skilled in the art will recognize that changes may be made in form and detail without departing from the spirit and scope of the invention. For example, while embodiments of the invention have been described with respect to English-language search strings, the invention is applicable to any search string that includes spaces. In particular, the invention is applicable to any search string for character-based languages. Accordingly, a search in any language can advantageously employ embodiments of the present invention.

1. A method for making additional terms available to a searching process, the method comprising:
receiving a string that incorporates a plurality of characters separated by at least one space;
concatenating the plurality of characters to form at least one additional term; and
providing said at least one additional term to the search process.

2. The method of claim 1, wherein,
receiving a string comprises receiving a string that incorporates a first set of characters separated by a space from a second set of characters; and
concatenating comprises concatenating the first and second sets of characters.

3. The method of claim 2, wherein the first and second sets of characters are each a single character.

4. The method of claim 1, and further comprising preprocessing the string.

5. The method of claim 4, wherein preprocessing includes removing at least one extraneous character from the string.

6. The method of claim 1, and further comprising suppressing at least one additional term.

7. The method of claim 1, wherein the method is executed upon a client system.

8. The method of claim 1, wherein the method is executed upon a server.

9. The method of claim 1, wherein the string includes N words, and wherein (N-1) (N/2) additional search terms are provided to the search process.

10. The method of claim 1, wherein the string is a search string.

11. The method of claim 1, wherein the string is a search result string.

12. The method of claim 1, wherein the method steps are executed as program instruction embedded on a computer readable medium.

13. A method for making additional terms available to a searching process, the method comprising:
receiving a string that incorporates a plurality of characters separated by at least one hyphen;
removing the at least one hyphen to form at least one additional term; and
providing said at least one additional term to the searching process.

14. The method of claim 13, wherein the method steps are executed as program instruction embedded on a computer readable medium.

15. A method for making additional terms available to a searching process, the method comprising:
receiving a string that incorporates a plurality of characters separated by at least one hyphen;
replacing the hyphen with a space to form at least one additional term; and
providing said at least one additional term to the search engine.

16. The method of claim 15, wherein the method steps are executed as program instruction embedded on a computer readable medium.

17. A method for making additional terms available to a searching process, the method comprising:
receiving a string that incorporates a plurality of characters separated by at least one space;
replacing said at least one space with a hyphen to form at least one additional term; and
providing said at least one additional term to the search engine.

18. The method of claim 17, wherein the method steps are executed as program instruction embedded on a computer readable medium.

19. A method for making additional terms available to a searching process, the method comprising:
receiving a string that incorporates a plurality of terms separated by a space or a hyphen;
generating at least one additional term by performing an operation selected from the group consisting of removing a space between the plurality of terms, removing a hyphen between the plurality of terms, replacing a space between the plurality of terms with a hyphen, and replacing a hyphen between the plurality of terms with a space; and
providing said at least one additional term to the searching process.
